(19) United States
(12) Patent Application Publication
(10) Pub. No.: US 2016/0148322 A1
(43) Pub. Date: May 26, 2016

(54) METHOD AND SYSTEM FOR SELECTING INTERCHANGEABLE ANALYTICS MODULES TO PROVIDE CUSTOMIZED TAX RETURN PREPARATION INTERVIEWS

(71) Applicant: Intuit Inc., Mountain View, CA (US)

(72) Inventors: Massimo Mascaro, San Diego, CA (US); Jonathan R. Goldman, Mountain View, CA (US); Luis Felipe Cabrera, Bellevue, WA (US); William T. Laaser, Palo Alto, CA (US)

(73) Assignee: INTUIT INC., Mountain View, CA (US)

(21) Appl. No.: 14/555,491

(22) Filed: Nov. 26, 2014

(51) Int. Cl. G06Q 40/00

(52) U.S. Cl. CPC G06Q 40/123

(57) ABSTRACT

A method and system selects one or more interchangeable analytics modules for use in a tax return preparation system to provide a customized electronic tax return preparation interview to a user, according to one embodiment. The method and system receive user data associated with a user, according to one embodiment. The method and system apply one of a number of selection techniques to determine which of one or more analytics modules to use within the tax return preparation system, according to one embodiment. The method and system apply the one or more analytics modules to the user data to determine the relevance of tax return preparation interview questions to the user, according to one embodiment. The method and system deliver tax return preparation interview questions to the user, based on the determined relevance of the number of tax return preparation interview questions to the user, according to one embodiment.

### BACKGROUND

Federal and State Tax law has become so complex that it is now estimated that each year Americans alone use over 6 billion person hours, and spend nearly 4 billion dollars, in an effort to comply with Federal and State Tax statutes. Given this level of complexity and cost, it is not surprising that more and more taxpayers find it necessary to obtain help, in one form or another, to prepare their taxes. Tax return preparation systems, such as tax return preparation software programs and applications, represent a potentially flexible, highly accessible, and affordable source of tax preparation assistance. However, traditional tax return preparation systems are, by design, fairly generic in nature and often lack the malleability to meet the specific needs of a given user.

For instance, traditional tax return preparation systems often present a fixed, e.g., predetermined and pre-packaged, structure or sequence of questions to all users as part of the tax return preparation interview process. Likewise, traditional tax return preparation systems often provide other user experiences associated with the tax return preparation systems, such as, but not limited to, interfaces, images, and assistance resources, in a static and generic manner to every user. This is largely due to the fact that the traditional tax return preparation system analytics used to generate a sequence of interview questions, and/or other user experiences, are static features that are typically an integral part of the tax return preparation system itself. These static features are hard-coded elements of the tax return preparation system and do not lend themselves to effective or efficient modification. As a result, using these traditional tax return preparation systems, the interview process, the user experience, and any analysis associated with the interview process and user experience, is a largely inflexible component of a given version of the tax return preparation system. Consequently, the interview processes and/or the user experience of traditional tax return preparation systems can only be modified through a redeployment of the tax return preparation system itself. Therefore, there is little or no opportunity for any analytics associated with interview process, and/or user experience, to evolve to meet a changing situation or the particular needs of a given taxpayer, even as more information about that taxpayer, and their particular circumstances, is obtained.

As a result of the current situation described above, the use of traditional tax return preparation systems subjects virtually every user with a more or less static set of sequenced interview questions and user experience elements, regardless of the user's particular needs, assets, and economic circumstances. The sequence of questions and the user experience is pre-determined based on a generic user model that is, in fact and by design, not accurately representative of any actual “real world” user. Consequently, irrelevant, and often confusing, interview questions are virtually always presented to any given real user under this static “one size fits all” approach. It is therefore not surprising that many users, if not all users, of these traditional tax return preparation systems experience, at best, an impersonal, unnecessarily long, confusing, and complicated, interview process and user experience. Clearly, this is not the type of experience that results in satisfied, loyal, and repeat customers.

Even worse is the fact that, in many cases, the hard-coded and static analysis features associated with traditional tax return preparation systems, and the resulting presentation of irrelevant questioning and user experiences, leads potential users of traditional tax return preparation systems, i.e., potential customers, to believe that the tax return preparation system is not applicable to them, and perhaps is unable to meet their specific needs. In other cases, the users simply become frustrated with the seemingly irrelevant lines of questioning and experience. Many of these potential users and customers then simply abandon the process and the tax return preparation systems completely, i.e., never become paying customers. Clearly, this is an undesirable result for both the potential user of the tax return preparation system and the provider of the tax return preparation system.

What is needed is a method and system for providing a tax return preparation system with an analysis capability that can be dynamically and independently modified and/or evolved to customize the interview process and user experience provided through a tax return preparation system.

### SUMMARY

Embodiments of the present disclosure address some of the shortcomings associated with traditional tax return preparation systems by providing a selection engine for various “pluggable”, e.g., interchangeable, analytics modules for use with a tax return preparation system. The selection engine, i.e., the analytics module selection engine, executes the selection, interface, and exchange, of the analytics modules within the tax return preparation system, without requiring the redeployment of either the tax return preparation system or any individual analytics module, in one embodiment. The selection engine is capable of interchanging different analytics modules within the tax return preparation system to advantageously evaluate the attributes and characteristics of a user's filing and to customize the tax return preparation interview based on the individual, similar to the approach of a human tax return preparation specialist. The analytics modules can include different types of algorithms, predictive models, analytic engines, and processes to support the customization of the tax return preparation interviews. For example, each of the interchangeable analytics modules can be configured to use a particular algorithm, model, or analytic for customizing one or more of: a prioritization of tax topics, a prioritization of tax return interview questions, tax return interview question sequences, user interfaces, images, user recommendations, and supplemental actions and recommendations. The analytics modules can also be linked or hierarchically organized to analyze user data and/or to delegate the analysis of all or part of the user data to one or more other analytics modules, according to one embodiment.

The analytics module selection engine chooses which analytics modules the tax preparation interview system executes, based on the situational characteristics of the interview, based on the history of the user, based on information acquired about the user, and/or based on data acquired directly or indirectly from the user, according to various embodiments. In other words, the selection engine employs one or more analytics module selection algorithms or selection techniques for choosing one or more analytics modules to execute within the tax return preparation system for the tax return interview, according to one embodiment. In one embodiment, an analytics module selection algorithm causes the selection engine to select the only analytics module that is available at the time. In one embodiment, an analytics module selection algorithm causes the selection engine to select an analytics module based on attributes of a specific situation, e.g., based on the proximity of a filing deadline. For example, if the interview occurs on or near the tax return filing deadline, the selection engine selects an analytics module that provides brief interviews, selects an analytics module that helps prepare tax return extensions of time, and/or selects an analytics module that assists with filing a tax return amendment, according to one embodiment. In one embodiment, an analytics module selection algorithm causes the selection engine to select an analytics module based on historical information related to the user, e.g., based on whether the tax filer is a first time user, a second time user, an intermediate user, or a seasoned user. In one embodiment, an analytics module selection algorithm causes the selection engine to select a particular analytics module as part of an A/B testing experiment. For example, an A/B testing experiment may concurrently distribute two analytics modules that are configured to accomplish the same task with different algorithms, and the selection engine selects one of the two analytics modules based on whether the tax filer is grouped in a first test group, i.e., cohort, or a second test group, for testing the effectiveness of different analytics module algorithms. In one embodiment, an analytics module selection algorithm causes the selection engine to select none of the available analytics modules, e.g., for a highly experienced user, so that the tax return preparation system presents all interview questions or presents a predetermined or unaltered sequence of interview questions to the user. In one embodiment, an analytics module selection algorithm causes the selection engine to select an analytics module that has been determined to be the overall best analytics module. In one embodiment, an analytics module selection algorithm causes the selection engine to select an analytics module based on characteristics of the computing system of the user, e.g., desktop computer, tablet computing device, online user, operating system, browser type, screen size, etc. In one embodiment, an analytics module selection algorithm causes the selection engine to select an analytics module that uses a predictive model, e.g., a model that determines a priority of interview questions and/or tax topics based on wages, zip code, marital status, and the like, of the user.

In one embodiment, the analytics module selection engine is configured to dynamically switch between one or more analytics modules at any time during the interview process, to improve the customization of the tax return preparation interview. In one embodiment, an analytics module selection algorithm causes the selection engine to initially apply a generic analytics module to the interview, and causes the selection engine to apply a different analytics module when more information is gathered from the user, or about the user. In one embodiment, an analytics module selection algorithm causes the selection engine to select an analytics module that chooses another analytics model for part of the interview and one or more other analytics modules for yet other parts of the interview. In other words, in one embodiment, the selection engine applies a meta-module to the interview to select other analytics modules to perform particular functions. In one embodiment, an analytics module selection algorithm causes the selection engine to dynamically change between different analytics modules throughout the interview process, based on user responses, response characteristics, and/or user clickstreams. In one embodiment, an analytics module selection technique includes applying a combination of one or more different analytics module selection algorithms (or techniques) during the tax return preparation interview process, to personalize and/or optimize the interview process for the user.

As noted above, in one embodiment, individualizing the tax return preparation interview process is accomplished, at least in part, by providing an analytics module selection engine that employs one or more analytics module selection techniques to apply one or more analytics modules to a tax return preparation interview. In one embodiment, the selected interchangeable analytics modules then process user data according to the specific analytics algorithm included in the selected interchangeable analytics modules to generate, specify, and/or determine which tax topics, question sequence, or user experience features to provide to the user. According to one embodiment, instead of modifying an entire tax return preparation system application, improvements to algorithms for individualizing the tax return preparation interview process, or other user experience features, may be updated simply by replacing or overwriting a prior version of one or more interchangeable analytics modules with an updated version of the interchangeable analytics modules, potentially saving significant time and development costs, and providing a “plug and play”, real-time/minimal-down-time modification capability.

Therefore, the various embodiments of the disclosure, and their associated benefits, as discussed herein, improve the technical field of electronic tax return preparation by providing an interchangeable analytics module architecture that provides an evolving, dynamic, and customized tax return preparation user experience. In addition, by individualizing/personalizing the tax return preparation interview and user experience, tax return preparation systems that use the interchangeable analytics module architecture discussed herein are able to efficiently gather more complete information from the user and provide a more thorough and customized analysis of potential tax return benefits for the user.

### BRIEF DESCRIPTION OF THE DRAWINGS

FIG. 1 is a block diagram of software architecture for providing a customized electronic tax return preparation interview, in accordance with one embodiment.

FIG. 2 is a block diagram of a process for providing a customized electronic tax return preparation interview, in accordance with one embodiment.

FIG. 3 is a flow diagram for customizing a computerized tax return preparation interview using a tax return preparation system with interchangeable analytics modules, in accordance with one embodiment.

Common reference numerals are used throughout the FIG.s and the detailed description to indicate like elements. One skilled in the art will readily recognize that the above FIG.s are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for providing a customized electronic tax return preparation interview by selecting and applying one or more interchangeable analytics modules to user data, according to various embodiments.

### Introductory System

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the terms “interview” and “interview process” include, but are not limited to, an electronic, software-based, and/or automated delivery of multiple questions to a user and an electronic, software-based, and/or automated receipt of responses from the user to the questions, to progress a user through one or more groups or topics of questions, according to various embodiments.

As used herein, the term “user experience” includes not only the interview process, interview process questioning, and interview process questioning sequence, but also other user experience features provided or displayed to the user such as, but not limited to, interfaces, images, assistance resources, backgrounds, avatars, highlighting mechanisms, icons, and any other features that individually, or in combination, create a user experience, as discussed herein, and/or as known in the art at the time of filing, and/or as developed after the time of filing.

### Hardware Architecture

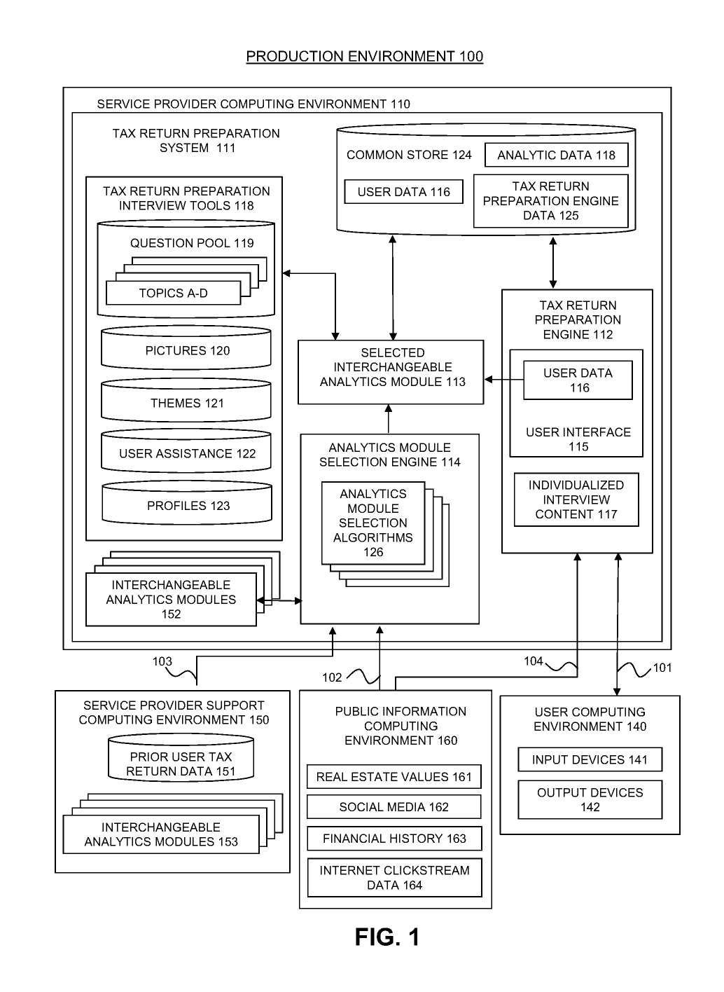

FIG. 1 illustrates a block diagram of a production environment 100 for selecting one or more interchangeable analytics modules to apply to user data to customize/personalize an electronic tax return preparation interview, according to one embodiment. The production environment 100 uses an analytics module selection engine to choose which interchangeable analytics modules the tax return preparation system executes, based on the situational characteristics of the interview, based on the history of the user, based on information acquired about the user, and/or based on data acquired directly or indirectly from the user, according to various embodiments. In one embodiment, the analytics module selection engine is configured to dynamically switch between one or more interchangeable analytics modules at any time during the interview process, to improve the personalization of the tax return preparation interview. In general, the production environment 100 personalizes a tax return preparation interview by receiving user data (from a user or from a third party), selecting one or more interchangeable analytics modules based on the user data, running the user data through the one or more selected interchangeable analytics modules, receiving customized interview content (e.g., like a sequence of prioritized questions) that is based on analyzing the user data with the one or more selected interchangeable analytics module, and presenting the customized interview content to the user, to progress the user through the tax return preparation interview, according to one embodiment. The one or more selected interchangeable analytics modules are an interchangeable or pluggable component within the production environment 100 and enables the production environment 100 to be executed with different algorithms or analysis routines by overwriting/replacing one interchangeable analytics module with another, according to one embodiment. Embodiments of the production environment 100 include various algorithms or techniques for selecting which interchangeable analytics modules to apply to user data to efficiently progress the user through the interview. The selection of different interchangeable analytics modules for different users and different circumstances enables the production environment 100 to customize/personalize a user's tax return preparation interview and to update the analytics module algorithms without altering other parts of the production environment 100, e.g., a tax return preparation engine, according to one embodiment.

As discussed above, there are various long standing shortcomings associated with traditional tax return preparation systems. Because traditional programs incorporate hard-coded analytics algorithms and fixed sequences of questions, user interfaces, and other elements of the user experience, these traditional tax return preparation systems provide a tax return interview that is impersonal and that has historically been a source of confusion and frustration to a user. When using traditional tax return preparation systems, users who are confused and frustrated by irrelevant questioning, and other generic user experience features, often attempt to terminate the interview process as quickly as possible, and/or provide, unwittingly, incorrect or incomplete data. As a result, traditional tax return preparation programs may fail to generate an optimum benefit to the user, e.g., the benefit the user would be provided if the user were interviewed with more pertinent questions, in a more logical order for that user.

As one illustrative example, a single-mother that is high-school educated and who makes less than $20,000 a year is more likely to be confused by questions related to interest income, dividend income, or other investments than her counterpart who is a business executive making a six-figure income. Traditionally, a professional tax return specialist was needed to adjust the nature of questions used in an interview based on initial information received from a user. However, professional tax return specialists are expensive and less accessible than an electronic tax return preparation system, e.g., a professional tax return specialist may have hours or operate in locations that are inconvenient to some taxpayers who have inflexible work schedules.

Inefficiencies associated with updating traditional tax return preparation systems is an additional long standing shortcoming. Even if potential improvements to traditional tax return preparation systems become available, the costs associated with developing, testing, releasing, and debugging a new version of the tax return preparation system each time a new or improved analytic algorithm is discovered, or defined, will often outweigh the benefits gained by a user, or even a significant sub-set of users.

The production environment 100 addresses some of the shortcomings associated with traditional tax return preparation systems by selecting one or more interchangeable analytics modules to apply to user data to personalize an electronic tax return preparation interview, according to one embodiment. The production environment 100 further addresses some of the shortcomings associated with traditional tax return preparation systems by providing interchangeable analytics modules that can be updated, overwritten, or otherwise modified without changing other aspects of the disclosed tax return preparation system. As a result, embodiments of the present disclosure improve the technical fields of user experience, electronic tax return preparation, and data flow and distribution by enabling a tax return preparation system to gather more complete information from the user and to provide a more thorough and customized analysis of potential tax return benefits for the user.

In addition, by minimizing, or potentially eliminating, the processing and presentation of irrelevant questions and other user experience features, implementation of embodiments of the present disclosure allows for significant improvement to the field of data collection and data processing. As one illustrative example, by minimizing, or potentially eliminating, the processing and presentation of irrelevant question data to a user, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

The production environment 100 includes a service provider computing environment 110, a user computing environment 140, a service provider support computing environment 150, and a public information computing environment 160 for customizing a tax return preparation interview for a user, according to one embodiment. The computing environments 110, 140, 150, and 160 are communicatively coupled to each other with a communication channel 101, a communication channel 102, and a communication channel 103, according to one embodiment.

The service provider computing environment 110 represents one or more computing systems such as a server, a computing cabinet, and/or distribution center that is configured to receive, execute, and host one or more tax return preparation systems (e.g., applications) for access by one or more users, e.g., tax filers, according to one embodiment.

The service provider computing environment 110 includes a tax return preparation system 111 that employs one or more selection algorithms or techniques for selecting one or more interchangeable analytics modules to apply to user data, to personalize a tax return preparation interview and user experience, according to one embodiment. The tax return preparation system 111 includes various components, databases, engines, modules, and/or data to support the selection and execution of interchangeable analytics modules, based on the situational characteristics of the interview, based on the history of the user, based on information acquired about the user, and/or based on data acquired directly or indirectly from the user, according to various embodiments. The tax return preparation system 111 includes a tax return preparation engine 112, a selected interchangeable analytics module 113, and an analytics module selection engine 114, according to one embodiment.

The tax return preparation engine 112 guides the user through the tax return preparation process by presenting the user with interview content, such as a sequence of interview questions and other user experience features, and by receiving user data from the user, according to one embodiment. The tax return preparation engine 112 includes a user interface 115 to receive user data 116 from the user and to present customized interview content 117 to the user, according to one embodiment. The user interface 115 includes one or more user experience elements and graphical user interface tools, such as, but not limited to, buttons, slides, dialog boxes, text boxes, drop-down menus, banners, tabs, directory trees, links, audio content, video content, and/or other multimedia content for communicating information to the user and for receiving the user data 116 from the user, according to one embodiment. The tax return preparation engine 112 employs the user interface 115 to receive the user data 116 from input devices 141 of the user computing environment 140 and employs the user interface 115 to transmit the customized interview content 117 (inclusive of various user experience elements) to output devices 142 of the user computing environment 140, according to one embodiment.

The user data 116 includes information collected directly and/or indirectly from the user, according to one embodiment. For example, in addition to information intentionally entered by the user, user data 116 also includes response times, mouse-overs, durations for entering responses, and other clickstream information, according to one embodiment. The user data 116 also includes information that is directly or indirectly entered by the user, such as, but not limited to, a name, a Social Security number, a government identification, a driver's license number, a date of birth, an address, a zip code, home ownership status, a marital status, an annual income, a job title, an employer's address, spousal information, children's information, asset information, medical history, occupation, website browsing preferences, a typical lingering duration on a website, information regarding dependents, salary and wages, interest income, dividend income, business income, farm income, capital gain income, pension income, IRA distributions, unemployment compensation, education expenses, health savings account deductions, moving expenses, IRA deductions, student loan interest deductions, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, and any other information that is currently used, that can be used, or that may be used in the future, for the electronic preparation of a user's tax return, according to various embodiments. In some implementations, the user data 116 is a subset of all of the user information used by the tax return preparation system 111 to prepare the user's tax return, e.g., is limited to marital status, children's information, and annual income.

In some embodiments, at least part of the user data 116 is acquired from sources that are external to the tax return preparation system 111. For example, the user data 116 can include prior user tax return data 151 or information gathered from the public information computing environment 160, such as, but not limited to, real estate values 161, social media 162, financial history 163, and internet clickstream data 164, according to one embodiment. The interchangeable analytics modules apply one or more algorithms to the user data 116 to prioritize tax topics and/or interview questions to provide interview content 117 that is personalized to each user.

The interview content 117 is received from the selected interchangeable analytics module 113 after the selected interchangeable analytics module 113 analyzes the user data 116, according to one embodiment. The interview content 117 can include, but is not limited to, a sequence with which interview questions are presented, the content/topics of the interview questions that are presented, the font sizes used while presenting information to the user, the length of descriptions provided to the user, themes presented during the interview process, the types of icons displayed to the user, the type of interface format presented to the user, images displayed to the user, assistance resources listed and/or recommended to the user, backgrounds presented, avatars presented to the user, highlighting mechanisms used and highlighted features, and any other features that individually, or in combination, create a user experience, as discussed herein, and/or as known in the art at the time of filing, and/or as developed after the time of filing, that are displayed in, or as part of, the user interface 115 to acquire information from the user, the length of descriptions provided to the user, themes presented during the interview process, and/or the type of user assistance offered to the user during the interview process, according to various embodiments.

The analytics module selection engine 114 executes the selection, interface, and exchange, of the interchangeable analytics modules 113, 152, and 153 within the tax return preparation system, without requiring the redeployment of either the tax return preparation system or any individual analytics module, according to one embodiment. The analytics module selection engine 114 is capable of interchanging different analytics modules 113, 152, and 153 within the tax return preparation system 111 to advantageously evaluate the attributes and characteristics of a user's filing and customize the tax return preparation interview based on the individual, similar to the approach of a human tax return preparation specialist. The interchangeable analytics modules 113, 152, and 153 include one or more algorithms, predictive models, analytic engines, and processes to support the customization of the tax return preparation interviews, according to one embodiment. For example, each of the interchangeable analytics modules 113, 152, and 153 can be configured to use a particular algorithm, model, or analytic for customizing one or more of: a prioritization of tax topics, a prioritization of tax return interview questions, tax return interview question sequences, user interfaces, images, user recommendations, and supplemental actions and recommendations. The interchangeable analytics modules 113, 152, and 153 can also be linked or hierarchically organized to analyze user data and/or to delegate the analysis of all or part of the user data to one or more other analytics modules, according to one embodiment.

The analytics module selection engine 114 chooses which analytics modules the tax preparation interview system executes, based on the situational characteristics of the interview, based on the history of the user, based on information acquired about the user, and/or based on data acquired directly or indirectly from the user, according to various embodiments. In other words, the selection engine employs one or more analytics module selection algorithms 126 (i.e., selection techniques) for choosing which one or more interchangeable analytics modules 113, 152, and 153 to execute within the tax return preparation system 111 for the tax return preparation interview, according to one embodiment. In one embodiment, one of the analytics module selection algorithms 126 causes the analytics module selection engine 114 to select the only analytics module that is available for execution by the tax return preparation system 111 at the time. In one embodiment, one of the analytics module selection algorithms 126 causes the analytics module selection engine 114 to select one of the interchangeable analytics modules 113, 152, and 153 based on attributes of a specific situation, e.g., based on the proximity of a filing deadline. For example, the analytics module selection engine 114 selects an analytics module that conducts brief interviews, selects an analytics module that prepares extension of time for tax return filings, and/or selects an analytics module for filing a tax return amendment, if the interview occurs on or near the tax return filing deadline, according to one embodiment.

In one embodiment, the analytics module selection algorithms 126 cause the analytics module selection engine 114 to select one or more of the interchangeable analytics modules 113, 152, and 153 based on historical information related to the user. Examples of historical information that is related to the user includes, but is not limited to, whether the tax filer is a first time user, a second time user, an intermediate user, or a seasoned user. The analytics module selection engine 114 may therefore be configured to select a different interchangeable analytics module for a first time user than for a second or third time user of the tax return preparation system 111, according to one embodiment.

In one embodiment, the analytics module selection algorithms 126 cause the analytics module selection engine 114 to select a particular one of the interchangeable analytics modules 113, 152, and 153 as part of an A/B testing experiment. For example, an A/B testing experiment may concurrently distribute two different analytics modules that are configured to accomplish the same task, but with different algorithms. The analytics module selection engine 114 selects between one of the two A/B test analytics modules, based on whether the tax filer is assigned to a first test group, i.e., cohort, or a second test group, according to one embodiment. The A/B testing experiment assists the service provider with testing the effectiveness of different analytics module algorithms by live testing new algorithms during interviews on actual customers or potential customers, i.e., tax filers.

In one embodiment, the analytics module selection algorithms 126 cause the analytics module selection engine 114 to select none of the available analytics modules. For example, a highly experienced user or tax return preparation specialist may, in one embodiment, elect not to receive a customized presentation of interview questions, so that the tax return preparation system 111 presents all interview questions or presents a predetermined or unaltered sequence of interview questions to the user.

In one embodiment, the analytics module selection algorithms 126 cause the analytics module selection engine 114 to select one of the interchangeable analytics modules 113, 152, and 153 that has been determined to be the overall best analytics module.

In one embodiment, the analytics module selection algorithms 126 causes the analytics module selection engine 114 to select interchangeable analytics modules 113, 152, and 153 based on characteristics of the computing system of the user, e.g., desktop computer, tablet computing device, online user, operating system, browser type, screen size, etc.

In one embodiment, the analytics module selection algorithms 126 cause the analytics module selection engine 114 to select one or more interchangeable analytics modules 113, 152, and 153 that use a predictive model, e.g., a model that determines a priority of interview questions and/or tax topics based on wages, zip code, marital status, and the like, of the user.

In one embodiment, the analytics module selection engine 114 is configured to dynamically switch between one or more interchangeable analytics modules 113, 152, and 153 at any time during the interview process, to improve the customization/personalization of the tax return preparation interview. In one embodiment, the analytics module selection algorithms 126 cause the analytics module selection engine 114 to initially apply a generic analytics module when not much is known about the user, and causes the selection engine to apply a different analytics module when more information is gathered from the user, or about the user. In one embodiment, the analytics module selection algorithms 126 cause the analytics module selection engine 114 to select one of the interchangeable analytics modules 113, 152, and 153 that chooses another analytics model for part of the interview and one or more other analytics modules for other parts of the interview. In other words, in one embodiment, the analytics module selection engine 114 applies a meta-module to the interview to select one or more sub-modules to perform particular functions. In one embodiment, the analytics module selection algorithms 126 cause the analytics module selection engine 114 to dynamically change between different analytics modules throughout the interview process, based on user responses, response characteristics, and/or user clickstreams. In one embodiment, an analytics module selection technique/algorithm includes applying a combination of one or more different analytics module selection algorithms 126 (or techniques) during the tax return preparation interview, to customize and/or optimize the interview process for the user.

The selected interchangeable analytics module 113 uses a variety of techniques to evaluate or analyze the user data 116, according to various embodiments. The selected interchangeable analytics module 113 receives the user data 116 from the tax return preparation engine 112, analyzes the user data 116, and generates the customized interview content 117 based on the user data 116 and based on the particular algorithm, predictive model, statistical engine, or analysis technique used by the selected interchangeable analytics module 113, according to one embodiment. The selected interchangeable analytics module 113 is an interchangeable component/module within the tax return preparation system 111, according to one embodiment. In other words, the selected interchangeable analytics module 113 can be modified, overwritten, deleted and/or conveniently replaced/updated with different and/or improved analytics modules, by the analytics module selection engine 114, without requiring modification to other components within the tax return preparation system 111, according to one embodiment. An advantage of implementing the selected interchangeable analytics module 113 as an interchangeable or pluggable module/component is that while one version of the selected interchangeable analytics module 113 is being executed, improved versions, i.e., other analytics modules, such as the interchangeable analytics modules 153 of service provider support computing environment 150, can be developed and tested. One or more of the other interchangeable analytics modules 152 and 153 can then made available to the tax return preparation engine 112 without making changes to the tax return preparation engine 112, or other components within the tax return preparation system 111, according to one embodiment.

In one embodiment, one or more of the interchangeable analytics modules 113, 152, and 153 are configured to delegate one or more analyses or tasks to one or more other interchangeable analytics modules during the tax return preparation interview. In one embodiment, one or more of the interchangeable analytics modules 113, 152, and 153 are configured to conduct a particular portion of the tax return preparation interview, to perform a particular task within a tax return preparation interview, and/or to perform an evaluation of the user data 116 for a particular tax topic or portion of a tax topic during the tax return preparation interview. In one embodiment, one or more of the interchangeable analytics modules 113, 152, and 153 are configured to employ one or more crowdsourcing techniques or other techniques to enable customers that have been serviced by an analytic module to provide feedback on its quality and merits.

As a result of this interchangeable or pluggable capability associated with the selected interchangeable analytics module 113, the static and inflexible nature of currently available tax return preparation applications is replaced with efficient and dynamically modifiable tax return preparation applications; thereby improving the technical fields of tax preparation, data analysis, and software application modification and update.

The selected interchangeable analytics module 113 is configured to receive and respond to commands, requests, instructions, and/or other communications from the tax return preparation engine 112 using an application programming interface (“API”), according to one embodiment. For example, the selected interchangeable analytics module 113 receives the user data 116 from the tax return preparation engine 112 through one or more API-based requests or commands from the tax return preparation engine 112, according to one embodiment. As another example, the selected interchangeable analytics module 113 transmits the customized interview content 117 to the tax return preparation engine 112 using one or more API-based functions, routines, and/or calls, according to one embodiment.

The selected interchangeable analytics module 113 draws from the tax return preparation interview tools 118 to generate the personalized interview content 117, according to one embodiment. The interview questions, tax topics, and other tools used to create the interview content 117 are included in the tax return preparation interview tools 118, according to one embodiment. The tax return preparation interview tools 118 include, but are not limited to, a question pool 119, pictures 120, themes 121, user assistance 122, and profiles 123, according to one embodiment. The question pool 119 includes all of the questions that can be presented or that must be made available for the user during the tax return preparation interview, according to one embodiment. The question pool 119 groups the questions by topic, according to one embodiment. In the specific illustrative example of FIG. 1, the question pool 119 includes four groups of questions that are represented by topic A, topic B, topic C, and topic D, according to one embodiment. While the question pool 119 is represented as having four topics, it is to be understood that the interview questions can be categorized into many more or less topics, e.g., 75 tax topics, according to various embodiments. Examples of topics, by which the question pool 119 may be grouped, include, but are not limited to, one or more of: earned income credit, child tax credit, charitable contributions, cars and personal property, education, medical expenses, taxes paid, moving expenses, job expenses, residential energy credits, property taxes, mortgage interest, interest and dividend income, and the like. In some implementations, the question pool 119 is grouped by high-level topics such as home, self and family, charitable contributions, education, medical, and the like. In other implementations, the question pool 119 includes low-level topics that are subgroups of the high-level topics, and include, but are not limited to, mortgage interest credit, homebuyer credit, elderly/disabled credit, legal fees, student loan interest, scholarships, state and local tax refunds, and and/or any other form of question or data acquisition, as discussed herein, and/or as known in the art at the time of filing, and/or as developed after the time of filing, according to various embodiments.

The pictures 120 and the themes 121 include variations for the graphical user interface that can be used by the tax return preparation engine 112 to provide a customized interview experience, and/or interface, to a user, according one embodiment. The pictures 120 include images of varying topics/themes, shapes, sizes, and colors that can be positioned proximate to questions or question topics to assist the user in understanding the gist of the series of questions being presented, according to one embodiment. For example, the pictures 120 can include a house, a doctor or stethoscope, children, a school, a car, and the like, according to one embodiment. The themes 121 include background colors, font colors, font sizes, animations, avatars, other theme-related graphics that can be applied to text or graphics within the user interface 115 while communicating with the user, and/or any other form of theme, as discussed herein, and/or as known in the art at the time of filing, and/or as developed after the time of filing, according to various embodiments.

The user assistance 122 includes various options for providing assistance to a user during the tax return preparation interview, according to one embodiment. Examples of the user assistance 122 include, but are not limited to, one or more of an instant message dialog box, an offer to call the user, a fax number, a mailing address, a phone number to which text messages may be transmitted, a URL or other link, an address to a tax return specialist that is local to the geographic location of the user, and/or any other form of user assistance, as discussed herein, and/or as known in the art at the time of filing, and/or as developed after the time of filing, according to various embodiments.

The profiles 123 represents a repository, data structure, or database of user data that is grouped based on commonalities between the user's and/or the users' data, according to one embodiment. The profiles 123 are grouped based on criteria such as marital status, approximate income range, job title, age ranges, homeownership status, employment status, zip code, level of education, and the like, according to one embodiment. Each profile of the profiles 123 can be associated with a particular set of user data variables. The particular set of user data variables can be associated with a particular sequence of topics in the question pool, with a particular theme, with a particular type of user assistance, and/or with one or more particular pictures, according to one embodiment. Accordingly, the production environment may associate a user with a particular one of the profiles 123 in order to indirectly assign the user to a particular sequence of topics in the question pool 119, according to one embodiment.

The selected interchangeable analytics module 113 uses one or more of the question pool 119, the pictures 120, the themes 121, the user assistance 122, and the profiles 123 to generate the customized interview content 117, according one embodiment. The sequence of the topics might, by default, be presented in the order topic A, topic B, topic C, and topic D, or the selected interchangeable analytics module 113 determines which of the topics A-D are more relevant to a user and determines which of the topics A-D are less relevant to the user, according to one embodiment. The selected interchangeable analytics module 113 then generates the personalized interview content 117 by creating a sequence of the topics A-D (and associated questions) that is more relevant to the user than the default sequence, according to one embodiment. In some embodiments, the selected interchangeable analytics module 113 may generate a sequence that is devoid of questions associated with one or more of the topics A-D. In another embodiment, the selected interchangeable analytics module 113 pushes the least relevant or apparently irrelevant questions to a single page at the end of the interview. For example, the selected interchangeable analytics module 113 can determine that, based on the user's age and income, topics B and C are highly relevant to the user and that topics A and D are likely to be a nuisance, i.e., highly irrelevant to the user. In such a case, the selected interchangeable analytics module 113 can cause the tax return preparation engine 112 to present topics B and C to the user first and present the irrelevant topics A and D for the user to optionally consider at the end of the interview. Additionally, the selected interchangeable analytics module 113 can cause the tax return preparation engine 112 to offer a reduced product price or to more quickly display some form of human resource assistance for the user based on a user's profile or based on the user data 116 to customize the user's interview experience, according to one embodiment. Accordingly, the selected interchangeable analytics module 113 can create the interview content 117 to prioritize or sequence the presentation of tax topics, and can otherwise customize the interview content to suit the user's probable preferences, according to one embodiment.

According to one embodiment, the components within the tax return preparation system 111 communicate with the selected interchangeable analytics module 113 using API functions, routines, and/or calls. However, according to another embodiment, the selected interchangeable analytics module 113 and the tax return preparation engine 112 can use a common store 124 for sharing, communicating, or otherwise delivering information between different features or components within the tax return preparation system 111. The common store 124 includes, but is not limited to, the user data 116 and tax return preparation engine data 125, according to one embodiment. The selected interchangeable analytics module 113 can be configured to store information and retrieve information from the common store 124 independent of information retrieved from and stored to the common store 124 by the tax return preparation engine 112, according to one embodiment. In addition to the selected interchangeable analytics module 113 and the tax return preparation engine 112, other components within the tax return preparation system 111 and other computer environments may be granted access to the common store 124 to facilitate communications with the selected interchangeable analytics module 113 and/or the tax return preparation engine 112, according to one embodiment.

The tax return preparation engine 112 can be configured to synchronously or asynchronously retrieve, apply, and present the customized interview content 117, according to various embodiments. For example, the tax return preparation engine 112 can be configured to wait to receive the customized interview content 117 from the selected interchangeable analytics module 113 before continuing to query or communicate with a user regarding additional information or regarding topics from the question pool 119, according to one embodiment. The tax return preparation engine 112 can alternatively be configured to submit user data 116 to the selected interchangeable analytics module 113 or submit another request to the selected interchangeable analytics module 113 and concurrently continue functioning/operating without waiting for a response from the selected interchangeable analytics module 113, according to one embodiment. In other words, the tax return preparation engine 112 can be configured to asynchronously continue to operate independent of the selected interchangeable analytics module 113 even though the selected interchangeable analytics module 113 is processing information that is needed by the tax return preparation engine 112. The tax return preparation engine 112 then incorporates information from the selected interchangeable analytics module 113 as the selected interchangeable analytics module 113 makes the information available, according to one embodiment. In one embodiment, a few initial or preliminary questions are presented to the user prior to executing the selected interchangeable analytics module 113. In other embodiments, the tax return preparation engine 112 calls the analytics module at any time during the tax return preparation interview process.

In one embodiment, the selection of selected interchangeable analytics module 113 from, as an example, a pool of interchangeable analytics modules, such as interchangeable analytics modules 152 and 153, is made based, at least in part, on a few initial or preliminary questions presented to the user. Additionally, in one embodiment, the selection and/or exchange of the selected interchangeable analytics module 113 is made based, at least in part, on any, or all of, user data 116, during any part of the user experience and interview process.

The interchangeability of interchangeable analytics module 113 represents a significant improvement over prior art architectures that included analytics hard-coded into the tax return preparation application which made it impractical to update the analytics, at least without also updating other components within the tax return preparation system. Various techniques can be used to incorporate the selected interchangeable analytics module 113 into the tax return preparation system 111, according to one embodiment. In another embodiment, the selected interchangeable analytics module 113 is interchangeably and/or pluggably integrated into the tax return preparation system 111 with an analytics module selection engine 114 that is discussed above.

As described above, the production environment 100 employs an architecture that supports one or more interchangeable, pluggable, and/or conveniently updatable interchangeable analytics modules for individualizing the tax return preparation interview for a user. Unlike traditional tax return preparation systems, the tax return preparation system 111 can reduce confusion, frustration, and trust issues of users by prioritizing the sequence of questions presented to the user so that more relevant questions are provided to the user and irrelevant questions are presented to the user in an optional, i.e., capable of being skipped, format, according to one embodiment. As a result, the features and techniques described herein are, in many ways, superior to the service received from a tax return specialist/preparer. For example, human error associated with a tax return specialist is eliminated, the hours of availability of the tax return specialist become irrelevant, the daily number of customers is not limited by the number of people a tax return specialist is able to visit within a daily basis, and the computerized tax return preparation process is unaffected by emotion, tiredness, stress, or other external factors that may be inherent in a tax return specialist during tax return season.

The various embodiments of the disclosure can be implemented to improve the technical fields of user experience, automated tax return preparation, data collection, and data processing. Therefore, the various described embodiments of the disclosure and their associated benefits amount to significantly more than an abstract idea. In particular, by individualizing or personalizing the tax return preparation interview, a tax return preparation application may be able to gather more complete information from the user and may be able to provide a more thorough and customized analysis of potential tax return benefits for the user, according to one embodiment. Furthermore, by employing an interchangeable, pluggable, and/or modular analytics module, new and/or improved versions of the analytics module may be developed and incorporated into the tax return preparation application to improve the interview process without having to rewrite, and re-test other components within the tax return preparation application, according to one embodiment.

In addition, as noted above, by minimizing, or potentially eliminating, the processing and presentation of irrelevant questions to a user, implementation of embodiments of the present disclosure allows for significant improvement to the field of data collection and data processing. As one illustrative example, by minimizing, or potentially eliminating, the processing and presentation of irrelevant question data to a user, implementation of embodiments of the present disclosure allows for relevant data collection using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

### Process

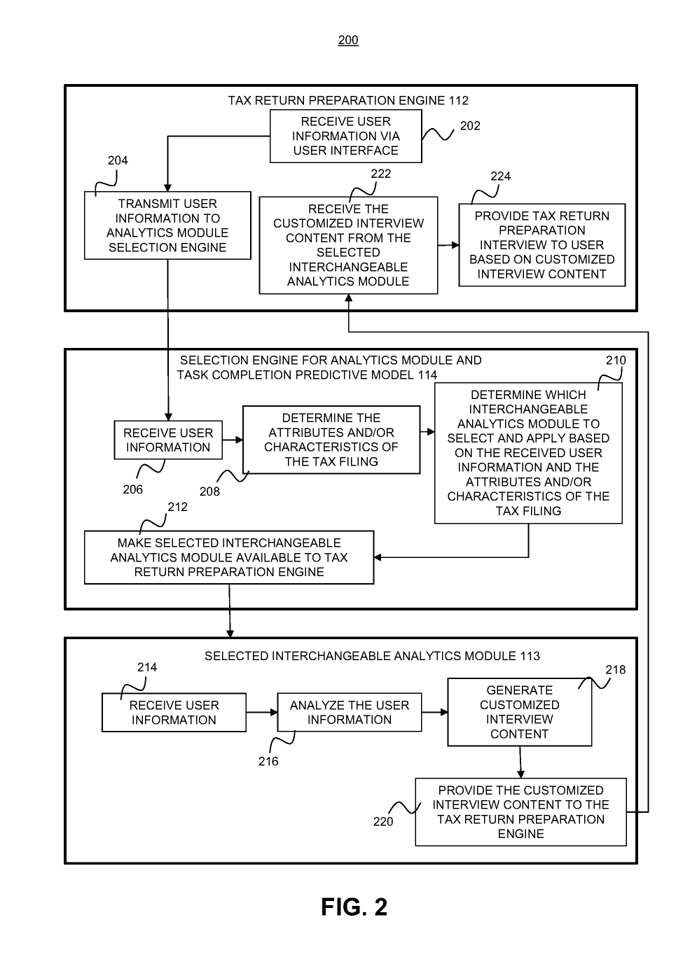

FIG. 2 illustrates a functional flow diagram of a process 200 for selecting interchangeable analytics modules to provide a customized tax return preparation interview, according to one embodiment.

At block 202, the tax return preparation engine 112 receives user information via a user interface, according to one embodiment. The tax return preparation engine 112 receives user information through one or more third party computing systems, e.g., the internal revenue service, public records services, or the like, according to one embodiment.

At block 204, the tax return preparation engine 112 transmits the user information to an analytics module selection engine 114, according to one embodiment.

At block 206, the analytics module selection engine 114 receives the user information from the tax return preparation engine 112, according to one embodiment.

At block 208, the analytics module selection engine 114 determines the attributes and/or characteristics of the tax filing, according to one embodiment. Examples of attributes and/or characteristics of the filing include, but are not limited to, the filing deadline, whether the user is assigned to an A/B test group, the history of the user with electronic tax return preparation systems, and the version (desktop or online) of the electronic tax return preparation system, according to one embodiment.

At block 210, the analytics module selection engine 114 determines which interchangeable analytics module to select and apply based on the received user information and the attributes and/or characteristics of the tax filing, according to one embodiment.

At block 212, the analytics module selection engine 114 makes the selected interchangeable analytics module available to the tax return preparation engine 112, according to one embodiment. For example, the analytics module selection engine 114 can copy the selected interchangeable analytics module into a particular range of memory addresses within a computing environment that are used by the tax return preparation application/system to execute the selected interchangeable analytics module, according to one embodiment. The analytics module selection engine 114 can copy the selected interchangeable analytics module into a memory location that is accessible by the other components of the tax return preparation application, and the analytics module selection engine 114 can update a pointer table or other data structure used by the tax return preparation application so that calls, requests, and/or routines that rely upon the selected interchangeable analytics module may be properly directed to the newly installed selected interchangeable analytics module, according to one embodiment.

At block 214, the selected interchangeable analytics module 113 receives user information, according to one embodiment. The selected interchangeable analytics module 113 can receive the user information from the tax return preparation engine 112 or from the analytics module selection engine 114 after the selected interchangeable analytics module 113 has been installed, according to various embodiments.

At block 216, the selected interchangeable analytics module 113 analyzes the user information, according to one embodiment. As described above, various analysis algorithms, such as predictive modeling or collaborative filtering, may be applied to the user information, according to one embodiment.

At block 218, the selected interchangeable analytics module 113 generates customized interview content, and/or other user experience features, according to one embodiment. The customized interview content can include, but is not limited to, one or more of: a sequence with which interview questions are presented, the content/topics of the interview questions that are presented, the font sizes used while presenting information to the user, the length of descriptions provided to the user, themes presented during the interview process, the types of icons displayed to the user, the type of interface format presented to the user, images displayed to the user, assistance resources listed and/or recommended to the user, backgrounds presented, avatars presented to the user, highlighting mechanisms used and highlighted features, and any other features that individually, or in combination, create a user experience, as discussed herein, and/or as known in the art at the time of filing, and/or as developed after the time of filing,

The customized interview content is compiled and/or generated based on the received user information and the analysis of the user information, according to one embodiment.

At block 220, the selected interchangeable analytics module 113 provides the customized interview content to the tax return preparation engine 112 for use by and/or delivery to the user, according to one embodiment. The selected interchangeable analytics module 113 can be configured to communicate with the tax return preparation engine 112 using an API, a common data store, or other techniques, according to various embodiments.

At block 222, the tax return preparation engine 112 receives the customized interview content from the selected interchangeable analytics module 113, according to one embodiment.

At block 224, the tax return preparation engine 112 provides the tax return preparation interview to the user based on the customized interview content, according to one embodiment. The tax return preparation engine 112 can provide the tax return preparation interview to the user synchronously, i.e., only after certain information is received from the selected interchangeable analytics module 113, according to one embodiment. The tax return preparation engine 112 can provide the tax return preparation interview to the user asynchronously, i.e., concurrent with data analysis being performed by the selected interchangeable analytics module 113, according to one embodiment. In one embodiment, providing the tax return preparation interview to the user based on the customized interview content transforms the user interface display from a default user interface into an individualized or customized user interface. In one embodiment, providing the tax return preparation interview to the user based on the customized interview content transforms a default sequence of interview questions into a new and/or modified relevancy-ordered sequence of interview questions. This, in turn, allows for significant improvement to the technical fields of user experience, electronic tax return preparation, data collection, and data processing by using fewer processing cycles and less communications bandwidth. As a result, embodiments of the present disclosure allow for improved processor performance, more efficient use of memory access and data storage capabilities, reduced communication channel bandwidth utilization, and faster communications connections. Consequently, computing and communication systems implementing and/or providing the embodiments of the present disclosure are transformed into faster and more operationally efficient devices and systems.

Although a particular sequence is described herein for the execution of the process 200, other sequences can also be implemented, according to other embodiments.

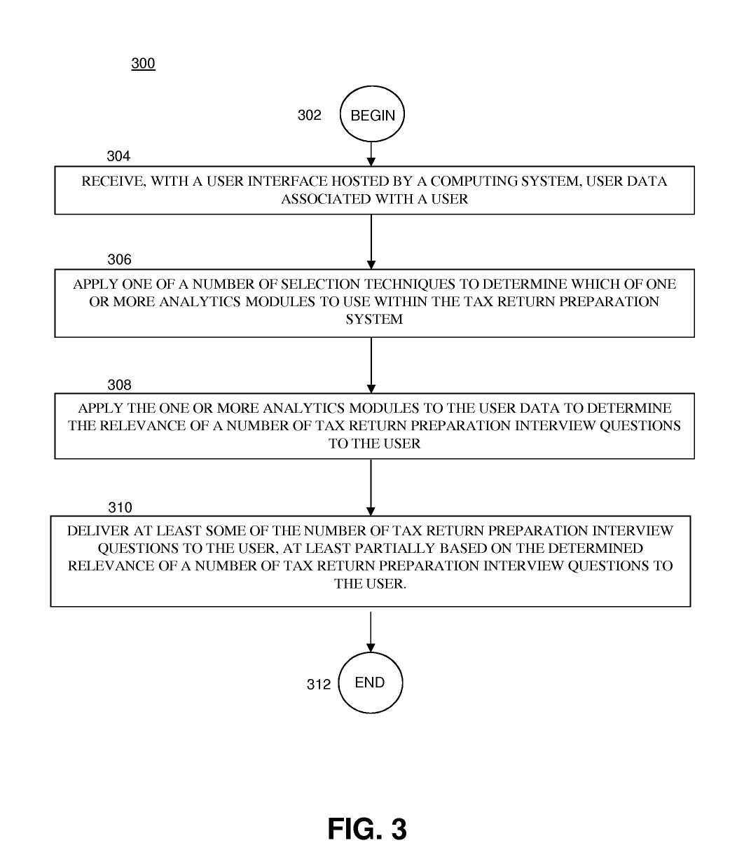

FIG. 3 illustrates a flow diagram of a process 300 for selecting interchangeable analytics modules in a tax return preparation system to provide a customized tax return preparation interview, according to various embodiments.

At block 302, the process begins.

At block 304, the process receives, with a user interface hosted by a computing system, user data associated with a user, according to one embodiment.

At block 306, the process applies one of a number of selection techniques to determine which of one or more analytics modules to use within the tax return preparation system, according to one embodiment. The one or more analytics modules are interchangeable within the tax return preparation system with other analytics modules, according to one embodiment. The one or more analytics modules are configured to evaluate at least part of the user data to determine a relevance of a number of tax return preparation interview questions to the user, according to one embodiment. The relevance of the number of tax return preparation interview questions is based at least partially on the user data, according to one embodiment.

At block 308, the process applies the one or more analytics modules to the user data to determine the relevance of the number of tax return preparation interview questions to the user, according to one embodiment.

At block 310, the process delivers at least some of the number of tax return preparation interview questions to the user, at least partially based on the determined relevance of the number of tax return preparation interview questions to the user, according to one embodiment.

At block 312, the process ends.

As noted above, the specific illustrative examples discussed above are but illustrative examples of implementations of embodiments of the method or process for individualizing the tax return preparation interview with an interchangeable, e.g., modular, analytics module. Those of skill in the art will readily recognize that other implementations and embodiments are possible. Therefore the discussion above should not be construed as a limitation on the claims provided below.

In accordance with one embodiment, a computing system implemented method selects one or more interchangeable analytics modules for use in a tax return preparation system to provide a customized electronic tax return preparation interview to a user. The method receives, with a user interface hosted by a computing system, user data associated with a user, according to one embodiment. The method applies one of a number of selection techniques to determine which of one or more analytics modules to use within the tax return preparation system, according to one embodiment. The one or more analytics modules are interchangeable within the tax return preparation system with other analytics modules, and the one or more analytics modules are configured to evaluate at least part of the user data to determine a relevance of a number of tax return preparation interview questions to the user, according to one embodiment. The relevance of the number of tax return preparation interview questions is based at least partially on the user data, according to one embodiment. The method applies the one or more analytics modules to the user data to determine the relevance of the number of tax return preparation interview questions to the user, according to one embodiment. The method delivers at least some of the number of tax return preparation interview questions to the user, at least partially based on the determined relevance of the number of tax return preparation interview questions to the user, according to one embodiment.

In accordance with one embodiment, a computer-readable medium includes a plurality of computer-executable instructions which, when executed by a processor, perform a method for selecting one or more interchangeable analytics modules for use in a tax return preparation system to provide a customized electronic tax return preparation interview to a user. The instructions include a tax return preparation engine that hosts a user interface to receive user data from a user and to provide interview content to the user to progress the user through the tax return preparation interview, according to one embodiment. The instructions include a selected interchangeable analytics module of the one or more interchangeable analytics modules, according to one embodiment. Each of the one or more interchangeable analytics modules is configured to apply a data evaluation model to the user data, and the interview content includes a plurality of questions, according to one embodiment. The selected interchangeable analytics module determines a sequence of delivery of the plurality of questions for the tax return preparation engine, and the sequence of delivery is at least partially based on a relevance of each of multiple tax-related topics to the user and at least partially based on the user data, according to one embodiment. The instructions include a selection engine that enables interchangeability between the selected interchangeable analytics module and others of the one or more interchangeable analytics modules, according to one embodiment. The selection engine applies one or more analytics module selection algorithms to determine the selected interchangeable analytics module, according to one embodiment.

In accordance with an embodiment, a system selects one or more interchangeable analytics modules for use in a tax return preparation system to provide a customized electronic tax return preparation interview to a user. The system includes at least one processor, according to one embodiment. The system includes at least one memory coupled to the at least one processor, the at least one memory having stored therein instructions which, when executed by any set of the one or more processors, perform a process for selecting one or more interchangeable analytics modules for use in a tax return preparation system to provide a customized electronic tax return preparation interview to a user, according to one embodiment. The process receives, with a user interface hosted by a computing system, user data associated with a user, according to one embodiment. The process applies one of a number of selection techniques to determine which of one or more analytics modules to use within the tax return preparation system, according to one embodiment. The one or more analytics modules are interchangeable within the tax return preparation system with other analytics modules, according to one embodiment. The one or more analytics modules are configured to evaluate at least part of the user data to determine a relevance of a number of tax return preparation interview questions to the user, and the relevance of the number of tax return preparation interview questions is based at least partially on the user data, according to one embodiment. The process applies the one or more analytics modules to the user data to determine the relevance of the number of tax return preparation interview questions to the user, according to one embodiment. The process delivers at least some of the number of tax return preparation interview questions to the user, at least partially based on the determined relevance of the number of tax return preparation interview questions to the user, according to one embodiment.

By minimizing, or potentially eliminating, the processing and presentation of irrelevant questions and/or other user experience elements to a user, implementation of embodiments of the present disclosure allows for significant improvement to the technical fields of user experience, electronic tax return preparation, data collection, and data processing. As one illustrative example, by minimizing, or potentially eliminating, the processing and presentation of irrelevant question data to a user, implementation of embodiments of the present disclosure use fewer human resources (e.g., time, focus) by not asking irrelevant questions and allows for relevant data collection by using fewer processing cycles and less communications bandwidth. As a result, embodiments of the present disclosure allow for improved processor performance, more efficient use of memory access and data storage capabilities, reduced communication channel bandwidth utilization, faster communications connections, and improved user efficiency. Consequently, computing and communication systems are transformed into faster and more operationally efficient devices and systems by implementing and/or providing the embodiments of the present disclosure. Therefore, implementation of embodiments of the present disclosure amount to significantly more than an abstract idea and also provide several improvements to multiple technical fields.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for selecting one or more interchangeable analytics modules for use in a tax return preparation system to provide a customized electronic tax return preparation interview to a user, comprising:
receiving, with a user interface hosted by a computing system, user data associated with a user;
applying one of a number of selection techniques to determine which of one or more analytics modules to use within the tax return preparation system,
wherein the one or more analytics modules are interchangeable within the tax return preparation system with other analytics modules,
wherein the one or more analytics modules are configured to evaluate at least part of the user data to determine a relevance of a number of tax return preparation interview questions to the user,
wherein the relevance of the number of tax return preparation interview questions is based at least partially on the user data;
applying the one or more analytics modules to the user data to determine the relevance of the number of tax return preparation interview questions to the user; and
delivering at least some of the number of tax return preparation interview questions to the user, at least partially based on the determined relevance of the number of tax return preparation interview questions to the user.

2. The method of claim 1, wherein at least part of the user data is selected from a group of user data consisting of:
data indicating the user's name;
data indicating the user's Social Security Number;
data indicating the user's government identification;
data indicating the user's a driver's license number;
data indicating the user's date of birth;
data indicating the user's address;
data indicating the user's zip code;
data indicating the user's home ownership status;
data indicating the user's marital status;
data indicating the user's annual income;
data indicating the user's job title;
data indicating the user's employer's address;
data indicating the user's spousal information;
data indicating the user's children's information;
data indicating the user's assets;
data indicating the user's medical history;
data indicating the user's occupation;
data indicating the user's website browsing preferences;
data indicating the user's typical lingering duration on a website;
data indicating the user's dependents;
data indicating the user's salary and wages;
data indicating the user's interest income;
data indicating the user's dividend income;
data indicating the user's business income;
data indicating the user's farm income;
data indicating the user's capital gain income;
data indicating the user's pension income;
data indicating the user's IRA distributions;
data indicating the user's unemployment compensation;
data indicating the user's educator expenses;
data indicating the user's health savings account deductions;
data indicating the user's moving expenses;
data indicating the user's IRA deductions;
data indicating the user's student loan interest deductions;
data indicating the user's tuition and fees;
data indicating the user's medical and dental expenses;
data indicating the user's state and local taxes;
data indicating the user's real estate taxes;
data indicating the user's personal property tax;
data indicating the user's mortgage interest;
data indicating the user's charitable contributions;
data indicating the user's casualty and theft losses;
data indicating the user's unreimbursed employee expenses;
data indicating the user's alternative minimum tax;
data indicating the user's foreign tax credit;
data indicating the user's education tax credits;
data indicating the user's retirement savings contribution;
data indicating the user's child tax credits; and
data indicating the user's residential energy credits.

3. The method of claim 1, wherein each of the number of selection techniques includes an algorithm for determining which of the one or more analytics modules to apply within the tax return preparation interview.

4. The method of claim 1, wherein the one of the number of selection techniques includes selecting an only available one of the one or more analytics modules, for use in the tax return preparation system.

5. The method of claim 1, wherein the one of the number of selection techniques includes selecting a best one of the one or more analytics modules, for use in the tax return preparation system.

6. The method of claim 1, further comprising:
repeatedly determining a selected one of the one or more analytics modules for application to the user data, during the tax return preparation interview.

7. The method of claim 1, wherein the one or more analytics modules are configured to evaluate at least part of the user data to determine a relevance of a number of tax return preparation interview questions to the user, by determining a relevance of a number of tax topics to the user, based at least partially on the user data.

8. The method of claim 1, wherein the one of the number of selection techniques includes selecting from the one or more analytics modules at least partially based on attributes of a tax filing.

9. The method of claim 8, wherein the attributes of the tax filing include a period of time between when the user receives the tax return preparation interview and a tax return filing deadline for the user.

10. The method of claim 9, wherein the one of the number of selection techniques applies a selected one of the one or more analytics modules that provides a briefest tax return preparation interview.

11. The method of claim 9, wherein the one of the number of selection techniques applies a selected one of the one or more analytics modules that prepares an extension of time for the tax filing.

12. The method of claim 9, wherein the one of the number of selection techniques applies a selected one of the one or more analytics modules that prepares a tax return amendment for filing the tax return after the tax return filing deadline.

13. The method of claim 1, wherein the one of the number of selection techniques includes selecting from the one or more analytics modules at least partially based on historical information about the user.

14. The method of claim 13, wherein the one of the number of selection techniques selects and applies different ones of the one or more analytics modules at least partially based on whether the user is a first time user, an intermediate user, or an experienced user.

15. The method of claim 1, wherein the one of the number of selection techniques includes selecting from the one or more analytics modules at least partially based on current characteristics of the user.

16. The method of claim 15, wherein the current characteristics of the user include one or more of:
a type of computing device used by the user for the tax return preparation interview;
a version of the tax return preparation system used by the user;
an operating system of the computing device used by the user for the tax return preparation interview; and
a type of web browser used for the tax return preparation interview.

17. The method of claim 1, wherein the one of the number of selection techniques includes selecting from the one or more analytics modules at least partially based on a predictive model that analyses at least part of the user data.

18. The method of claim 1, wherein the one of the number of selection techniques includes selecting from the one or more analytics modules at least partially based on a combination of some of the number of selections techniques.

19. The method of claim 1, wherein the one of the number of selection techniques includes:
starting the tax return preparation interview with a generic one of the one or more analytics modules; and
exchanging the generic one of the one or more analytics modules with a more relevant one of the one or more analytics modules during the tax return preparation interview, at least partially based on user data received from the user during the tax return preparation interview.

20. The method of claim 1, wherein the one of the number of selection techniques includes selecting from the one or more analytics modules at least partially based on which test group the user is assigned to during a test of algorithms for some of the one or more analytics modules,
wherein the test of the algorithms for some of the one or more analytics modules includes assigning a particular function to at least two of the one or more analytics modules and using different algorithms to perform the particular function in the at least two of the one or more analytics modules.

21. The method of claim 1, wherein the one of the number of selection techniques applies a selected one of the one or more analytics modules that delegates tasks to one or more other ones of the one or more analytics modules.

22. The method of claim 1, wherein the one of the number of selection techniques applies a selected one of the one or more analytics modules that delegates a first analysis of the user data to a first of the one or more analytics modules and delegates a second analysis of the user data to a second of the one or more analytics modules.

23. The method of claim 1, wherein the one of the number of selection techniques applies a selected one of the one or more analytics modules that acquires user feedback to determine, from the user, one or more of the quality and merits of at least some of the one or more analytics modules.

24. The method of claim 23, wherein selection of the one or more analytics modules employs crowdsourcing techniques to determine the one or more of the quality and merits of at least some of the one or more analytics modules.

25. A computer-readable medium having a plurality of computer-executable instructions which, when executed by a processor, perform a method for selecting one or more interchangeable analytics modules for use in a tax return preparation system to provide a customized electronic tax return preparation interview to a user, the instructions comprising:
a tax return preparation engine that hosts a user interface to receive user data from a user and to provide interview content to the user to progress the user through the tax return preparation interview;
a selected interchangeable analytics module of the one or more interchangeable analytics modules,
wherein each of the one or more interchangeable analytics modules is configured to apply a data evaluation model to the user data,
wherein the interview content includes a plurality of questions,
wherein the selected interchangeable analytics module determines a sequence of delivery of the plurality of questions for the tax return preparation engine,
wherein the sequence of delivery is at least partially based on a relevance of each of multiple tax-related topics to the user and at least partially based on the user data; and
a selection engine that enables interchangeability between the selected interchangeable analytics module and others of the one or more interchangeable analytics modules,
wherein the selection engine applies one or more analytics module selection algorithms to determine the selected interchangeable analytics module.

26. The computer-readable medium of claim 25, wherein the one or more analytics module selection algorithms cause the selection engine to switch between the one or more interchangeable analytics modules during the tax return preparation interview.

27. The computer-readable medium of claim 25, wherein the one or more analytics module selection algorithms cause the selection engine to determine the selected interchangeable analytics module at least partially based on characteristics of the tax filing,
wherein the characteristics of the tax filing include a proximity of the tax return preparation interview to a tax return filing deadline.

28. The computer-readable medium of claim 25, wherein the one or more analytics module selection algorithms cause the selection engine to determine the selected interchangeable analytics module at least partially based an experience level of the user with the tax return preparation system.

29. A system for selecting one or more interchangeable analytics modules for use in a tax return preparation system to provide a customized electronic tax return preparation interview to a user, the system comprising:
at least one processor; and
at least one memory coupled to the at least one processor, the at least one memory having stored therein instructions which, when executed by any set of the one or more processors, perform a process for selecting one or more interchangeable analytics modules for use in a tax return preparation system to provide a customized electronic tax return preparation interview to a user, the process including:
receiving, with a user interface hosted by a computing system, user data associated with a user;
applying one of a number of selection techniques to determine which of one or more analytics modules to use within the tax return preparation system,
wherein the one or more analytics modules are interchangeable within the tax return preparation system with other analytics modules,
wherein the one or more analytics modules are configured to evaluate at least part of the user data to determine a relevance of a number of tax return preparation interview questions to the user,
wherein the relevance of the number of tax return preparation interview questions is based at least partially on the user data;
applying the one or more analytics modules to the user data to determine the relevance of the number of tax return preparation interview questions to the user; and
delivering at least some of the number of tax return preparation interview questions to the user, at least partially based on the determined relevance of the number of tax return preparation interview questions to the user.

30. The system of claim 29, wherein the process further comprises:
repeatedly determining a selected one of the one or more analytics modules for application to the user data, during the tax return preparation interview.

31. The system of claim 29, wherein the one or more analytics modules are configured to evaluate at least part of the user data to determine a relevance of a number of tax return preparation interview questions to the user, by determining a relevance of a number of tax topics to the user, based at least partially on the user data.

32. The system of claim 29, wherein the one of the number of selection techniques includes selecting from the one or more analytics modules at least partially based on attributes of a tax filing.

33. The system of claim 32, wherein the attributes of the tax filing include a period of time between when the user receives the tax return preparation interview and a tax return filing deadline for the user.

34. The system of claim 33, wherein the one of the number of selection techniques applies a selected one of the one or more analytics modules that provides a briefest tax return preparation interview.

35. The system of claim 29, wherein the one of the number of selection techniques includes selecting from the one or more analytics modules at least partially based on historical information about the user.

36. The system of claim 35, wherein the one of the number of selection techniques selects and applies different ones of the one or more analytics modules at least partially based on whether the user is a first time user, an intermediate user, or an experienced user.

37. The system of claim 29, wherein the one of the number of selection techniques includes selecting from the one or more analytics modules at least partially based on a combination of some of the number of selections techniques.

38. The system of claim 29, wherein the one of the number of selection techniques includes:
starting the tax return preparation interview with a generic one of the one or more analytics modules; and
exchanging the generic one of the one or more analytics modules with a more relevant one of the one or more analytics modules during the tax return preparation interview, at least partially based on user data received from the user during the tax return preparation interview.

39. The system of claim 29, wherein the one of the number of selection techniques includes selecting from the one or more analytics modules at least partially based on which test group the user is assigned to during a test of algorithms for some of the one or more analytics modules,
wherein the test of the algorithms for some of the one or more analytics modules includes assigning a particular function to at least two of the one or more analytics modules and using different algorithms to perform the particular function in the at least two of the one or more analytics modules.

40. The system of claim 29, wherein the one of the number of selection techniques applies a selected one of the one or more analytics modules that delegates a first analysis of the user data to a first of the one or more analytics modules and delegates a second analysis of the user data to a second of the one or more analytics modules.
